(19) United States
(12) Patent Application Publication
(10) Pub. No.: US 2017/0303766 A1
(43) Pub. Date: Oct. 26, 2017

(54) Controlling Operation of Dishwasher Motor

(71) Applicant: General Electric Company, Schenectady, NY (US)

(72) Inventors: Andrew L. Reder, Louisville, KY (US); Davide Jonathan Leone, Louisville, KY (US)

(21) Appl. No.: 15/135,630

(22) Filed: Apr. 22, 2016

(51) Int. Cl. A47L 15/46; A47L 15/00; A47L 15/23; A47L 15/42; A47L 15/50; G05B 19/416

(52) U.S. Cl. CPC A47L 15/46; G05B 19/4163; A47L 15/0052; A47L 15/23; A47L 15/4206; A47L 15/0021; A47L 15/507; A47L 15/502; A47L 15/4293; A47L 15/4261; A47L 15/4259; A47L 15/4246; A47L 15/4225; A47L 2401/30; A47L 2501/05; A47L 2301/04; G05B 2219/37312

(57) ABSTRACT

Systems and methods for controlling operation of a dishwashing appliance are disclosed. For instance, data indicative of a supply voltage associated with a dishwashing appliance can be received. The supply voltage can be compared to a nominal voltage associated with the dishwashing appliance. One or more voltage control parameters can be determined based at least in part on the comparison. A speed of a motor associated with the dishwashing appliance can be adjusted based at least in part on the voltage control parameters.

### FIELD OF THE INVENTION

The present subject matter relates generally controlling operation of a dishwashing appliance, and more particularly to controlling operation of a motor associated with a dishwashing appliance based at least in part on supply voltages.

### BACKGROUND OF THE INVENTION

Dishwasher appliances generally include a tub that defines a wash compartment. Rack assemblies can be mounted within the wash chamber of the tub for receipt of articles for washing. Spray assemblies within the wash chamber can apply or direct wash fluid towards articles disposed within the rack assemblies in order to clean such articles. Multiple spray assemblies can be provided including e.g., a lower spray arm assembly mounted to the tub at a bottom of the wash chamber, a mid-level spray arm assembly mounted to one of the rack assemblies, and/or an upper spray assembly mounted to the tub at a top of the wash chamber. Other configurations may be used as well.

Dishwasher appliances further typically include a fluid circulation system which is in fluid communication with the spray assemblies for circulating fluid to the spray assemblies. The fluid circulation system generally receives fluid from the wash chamber, filters soil from the fluid, and flows the filtered fluid either to the spray assemblies or to a drain. To facilitate the flow of filtered fluid to the spray assemblies and/or drain, a pump is typically included in the fluid circulation system.

Such fluid circulation systems typically include a pump having an impeller and a motor (e.g. a three-phase motor) that drives the impeller. Operation of the motor can vary with the supply voltage applied to the motor. For instance, low supply voltage can reduce motor speed, which can adversely affect wash performance. In addition, high supply voltage may result in an increase of emitted sound by the motor during operation.

### BRIEF DESCRIPTION OF THE INVENTION

Aspects and advantages of embodiments of the present disclosure will be set forth in part in the following description, or may be learned from the description, or may be learned through practice of the embodiments.

One example embodiment of the present disclosure is directed to a method of controlling operation of a dishwashing appliance. The method includes receiving data indicative of a supply voltage associated with a dishwashing appliance. The method further includes comparing the supply voltage to a nominal supply voltage associated with the dishwashing appliance. The method further includes determining one or more voltage control parameters based at least in part on the comparison of the supply voltage to the nominal supply voltage. The method further includes adjusting a speed of a motor associated with the dishwashing appliance based at least in part on the voltage control parameters.

Another example aspect of the present disclosure is directed to a dishwashing appliance. The dishwashing appliance includes a tub that defines a wash chamber for receipt of articles for washing, a pump motor configured to direct a flow of fluid within the dishwashing appliance, and a power source coupled to the pump motor, the power source configured to provide an alternating current signal to the pump motor. The dishwashing appliance further includes one or more control devices configured to control operation of the pump motor by receiving data indicative of a supply voltage associated with the power source, comparing the supply voltage to a nominal supply voltage associated with the dishwashing appliance, determining one or more voltage control parameters based at least in part on the comparison of the supply voltage to the nominal supply voltage, and adjusting a speed of the pump motor based at least in part on the voltage control parameters.

Yet another example aspect of the present disclosure is directed to a control system for a dishwashing appliance. The control system includes one or more control devices configured to receive data indicative of a supply voltage associated with a dishwashing appliance. The dishwashing appliance includes a tub that defines a wash chamber for receipt of articles for washing, a pump motor configured to direct a flow of fluid within the dishwashing appliance, and a power source coupled to the pump motor. The power source is configured to provide an alternating current signal to the pump motor. The one or more control devices are further configured to compare the supply voltage to a nominal supply voltage associated with the power source, determine one or more voltage control parameters based at least in part on the comparison of the supply voltage to the nominal supply voltage, and adjust a speed of the pump motor based at least in part on the voltage control parameters to substantially achieve a nominal motor speed.

Variations and modifications can be made to these example aspects of the present disclosure.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIGS. 1-2 depict an example dishwashing appliance according to example embodiments of the present disclosure;

FIG. 3 depicts an example system for controlling operation of a motor according to example embodiments of the present disclosure;

FIG. 4 depicts a chart of example motor speeds over a range of voltages according to example embodiments of the present disclosure; and

FIG. 5 depicts a flow diagram of an example method of controlling operation of a motor according to example embodiments of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Example aspects of the present disclosure are directed to controlling operation of an appliance based at least in part on a supply voltage associated with the appliance. For instance, data indicative of a supply voltage associated with an appliance can be, measured, monitored or otherwise received. The supply voltage can be compared to a nominal supply voltage associated with the appliance. One or more voltage control parameters associated with the appliance can be determined based at least in part on the comparison of the measured supply voltage to the nominal supply voltage. The rotational speed of a motor associated with the appliance can be adjusted based at least in part on the voltage control parameters.

More particularly, in some implementations, the appliance can be a dishwashing appliance. The supply voltage can be an alternating current (AC) voltage signal applied to a dishwasher motor via a triac device. As indicated above, supply voltage can impact dishwasher performance. For instance, a low supply voltage can cause a reduced motor speed, which can affect wash performance. Conversely, a high supply voltage can cause an increased motor speed, which can result in an increased amount of sound emitted during operation.

To compensate for such affected wash performance and/or amount of emitted sound, the voltage applied to the dishwasher motor can be regulated to substantially achieve a desired motor speed. For instance, the supply voltage can be compared to a nominal supply voltage, and the motor speed can be adjusted to compensate for the difference between the supply voltage and the nominal supply voltage. For instance, if the monitored supply voltage is less than the nominal supply voltage, the voltage applied to the motor can be increased. Conversely, if the monitored supply voltage is greater than the nominal supply voltage, the voltage applied to the motor can be decreased.

In some implementations, the voltage applied to the motor can be regulated by one or more semiconductor switching elements, such as one or more triac devices, thyristors, silicon-controlled rectifiers, or other semiconductor devices. In such implementations, the semiconductor elements can be controlled to conduct at least a portion of the supply voltage signal to the motor. For instance, in implementations, wherein a triac device is used to regulate voltage to the motor, a firing angle of the triac device can be adjusted to regulate the voltage to the motor. The firing angle of the triac device can correspond to a delay between a zero-crossing of the AC supply voltage signal and a time when the triac begins conducting current to the motor. As will be understood by those skilled in the art, when a gate of the triac device is triggered by a gating voltage (e.g. gate pulse) having a sufficient magnitude, the triac device can begin conducting current through the main terminals of the triac device. The triac device can then turn off when the current through the main terminals falls to about zero volts. In this manner, a gate pulse can be provided to the triac gate, and the triac device can be turned on at some time during a half cycle of the AC signal, and the triac can continue to conduct until the end of the half cycle. The gate pulse can be provided at a determined firing angle associated with the AC signal. Such gating techniques can be repeated during one or more subsequent half cycles of the AC signal. In this manner, the percentage of each half cycle conducted to the motor by the triac device can be determined by the corresponding firing angles of each half cycle.

As indicated above, the triac firing angles can be determined based at least in part on the comparison between the nominal supply voltage and the measured supply voltage. In particular, the firing angles can be adjusted to adjust a motor speed based at least in part on the comparison between the nominal supply voltage and the measured supply voltage. In some implementations, the firing angle adjustments can be determined by accessing a lookup table stored in a memory associated with the dishwashing appliance. For instance, the lookup table can correlate or otherwise map supply voltage, motor speed, and/or triac firing angles. The lookup table can be accessed to determine a firing angle adjustment that needs to be made to operate the motor at substantially the nominal speed. In this manner, the motor can be controlled to operate at the nominal speed independent of the supply voltage.

In some implementations, control methods disclosed herein can be performed at one or more times associated with operation of the dishwashing appliance. For instance, in some implementations, a pre-cycle voltage check may occur prior to initiation of a dishwashing cycle by the dishwashing appliance. For instance, a dishwashing appliance may be configured to receive an input from a user indicative of a request to initiate a dishwashing cycle. The dishwashing appliance can then initiate the dishwashing cycle based at least in part on the user input. A pre-cycle voltage check can occur at one or more times prior to initiation of the dishwashing cycle. For instance, the pre-cycle voltage check can occur prior to receiving the user input, or subsequent to receiving the user input, but before initiation of the dishwashing cycle. As another example, one or more voltage checks can occur during a dishwashing cycle (e.g. subsequent to initiation of the dishwashing cycle). For instance, the voltage check can occur on a periodic basis during the dishwashing cycle. As indicated, once the voltage-check occurs, the voltage can be compared to a nominal voltage and the motor speed can be adjusted in accordance with example embodiments of the present disclosure.

In some implementations, initiation of a dishwashing cycle can include a “soft-start,” wherein the amount of voltage applied to the motor is gradually increased from zero. For instance, gradually increasing the voltage applied to the motor can include gradually decreasing the firing angle of the triac. In this manner, the motor speed gradually increases with the gradual increase of the applied voltage. Implementing such “soft-start” technique can reduce or eliminate a noise surge that can otherwise occur during initiation of a dishwashing cycle.

In some implementations, the measured supply voltage can be further compared to a nominal voltage range. The nominal voltage range can be indicative of a supply voltage range wherein safe operation of the dishwashing appliance can occur. In such implementations, when the supply voltage falls outside of the nominal voltage range, the dishwashing cycle can be ceased or otherwise aborted, and a fault can be recorded. When the supply voltage falls within the nominal voltage range, the process can continue, and operation of the dishwashing appliance can be controlled in accordance with example embodiments of the present disclosure.

In some implementations, the dishwashing appliance can learn from previous behavior of the dishwashing appliance and take one or more preemptive actions based on the previous behavior. For instance, if the triac firing angle is adjusted in the same manner prior to initiation of a threshold number of consecutive dishwashing cycles, the firing angle may be preemptively adjusted in the same manner prior to initiation of one or more subsequent dishwashing cycles. As another example, if the triac firing angle is adjusted in the same manner during a threshold number of consecutive dishwashing cycles, the firing angle may be preemptively adjusted in the same manner during one or more subsequent dishwashing cycles. In particular, a preemptive adjustment of firing angles may be performed prior to a supply voltage measurement, such that the firing angle adjustment occurs independently of a supply voltage measurement.

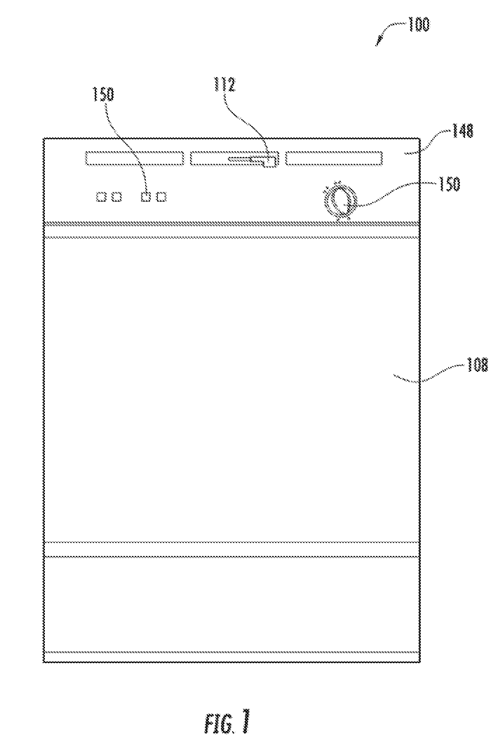

With reference now to the figures, example embodiments of the present disclosure will be discussed in greater detail. For instance, FIGS. 1 and 2 depict one embodiment of a domestic dishwashing appliance 100 that may be configured in accordance with aspects of the present disclosure. As shown in FIGS. 1 and 2, the dishwashing appliance 100 may include a cabinet 102 having a tub 104 therein defining a wash chamber 106. The tub 104 may generally include a front opening (not shown) and a door 108 hinged at its bottom 110 for movement between a normally closed vertical position (shown in FIGS. 1 and 2), wherein the wash chamber 106 is sealed shut for washing operation, and a horizontal open position for loading and unloading of articles from the dishwasher. As shown in FIG. 1, a latch 112 may be used to lock and unlock the door 108 for access to the chamber 106.

As is understood, the tub 104 may generally have a rectangular cross-section defined by various wall panels and/or walls. For example, as shown in FIG. 2, the tub 104 may include a top wall 160 and a bottom wall 162 spaced apart from one another along a vertical direction V of the dishwashing appliance 100. Additionally, the tub 104 may include a plurality of sidewalls 164 (e.g., four sidewalls) extending between the top and bottom walls 160, 162. It should be appreciated that the tub 104 may generally be formed from any suitable material. However, in several embodiments, the tub 104 may be formed from a ferritic material, such as stainless steel.

As particularly shown in FIG. 2, upper and lower guide rails 114, 116 may be mounted on opposing side walls 164 of the tub 104 and may be configured to accommodate roller-equipped rack assemblies 120 and 122 configured for supporting articles for washing within the wash chamber of the tub. Each of the rack assemblies 120, 122 may be fabricated into lattice structures including a plurality of elongated members 124 (for clarity of illustration, not all elongated members making up assemblies 120 and 122 are shown in FIG. 2). Additionally, each rack 120, 122 may be adapted for movement between an extended loading position (not shown) in which the rack is substantially positioned outside the wash chamber 106, and a retracted position (shown in FIGS. 1 and 2) in which the rack is located inside the wash chamber 106. This may be facilitated by rollers 126 and 128, for example, mounted onto racks 120 and 122, respectively. As is generally understood, a silverware basket (not shown) may be removably attached to rack assembly 122 for placement of silverware, utensils, and the like, that are otherwise too small to be accommodated by the racks 120, 122.

Additionally, the dishwashing appliance 100 may also include a lower spray-arm assembly 130 that is configured to be rotatably mounted within a lower region 132 of the wash chamber 106 directly above the bottom wall 162 of the tub 104 so as to rotate in relatively close proximity to the rack assembly 122. As shown in FIG. 2, a mid-level spray-arm assembly 136 may be located in an upper region of the wash chamber 106, such as by being located in close proximity to the upper rack 120. Moreover, an upper spray assembly 138 may be located above the upper rack 120.

As is generally understood, the lower and mid-level spray-arm assemblies 130, 136 and the upper spray assembly 138 may generally form part of a fluid circulation assembly 140 for circulating water and dishwasher fluid within the tub 104. As shown in FIG. 2, the fluid circulation assembly 140 may also include a pump 142 located in a machinery compartment 144 located below the bottom wall 162 of the tub 104, as is generally recognized in the art.

The pump 142 can include or otherwise be coupled to a pump motor configured to direct the circulation of fluids within wash chamber 106. The pump 142 is generally operable to urge and direct the flow of fluid within the wash chamber 106. Pump 142 may, for example, include an impeller (not shown). The impeller may rotate when activated to influence the flow of fluid within the wash chamber 106. The pump 142 may further include a motor (not shown) that is connected to the impeller. For instance, a shaft may extend between and connect the motor and the impeller, such that operation of the motor rotates the impeller.

Additionally, each spray-arm assembly 130, 136 may include an arrangement of discharge ports or orifices for directing washing liquid onto dishes or other articles located in rack assemblies 120 and 122, which may provide a rotational force by virtue of washing fluid flowing through the discharge ports. The resultant rotation of the lower spray-arm assembly 130 provides coverage of dishes and other dishwasher contents with a washing spray.

The dishwashing appliance 100 may be further equipped with a controller 146 configured to regulate operation of the dishwasher 100. The controller 146 can include any number of control devices and can generally include one or more memory devices and one or more processors, such as one or more general or special purpose microprocessors operable to execute programming instructions or micro-control code associated with a cleaning cycle. The processors and/or memory devices can be configured to perform a variety of computer-implemented functions and/or instructions (e.g. performing the methods, steps, calculations and the like and storing relevant data as disclosed herein). The instructions when executed by the processor(s) can cause the processor(s) to perform operations, including providing control commands to various aspects of dishwashing appliance 100.

As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. The processor is also configured to compute advanced control algorithms and communicate to a variety of Ethernet or serial-based protocols (Modbus, OPC, CAN, etc.). Additionally, the memory device(s) may generally comprise memory element(s) including, but not limited to, computer readable medium (e.g. random access memory (RAM)), computer readable non-volatile medium (e.g. read-only memory, or a flash memory), a floppy disk, a compact disc-read only memory (CD-ROM), a magneto-optical disk (MOD), a digital versatile disc (DVD) and/or other suitable memory elements. Such memory device(s) may generally be configured to store suitable computer-readable instructions that, when implemented by the processor(s), configure controller 104 to perform the various functions as described herein. The memory may be a separate component from the processor or may be included onboard within the processor.

The controller 146 may be positioned in a variety of locations throughout dishwashing appliance 100. In the illustrated embodiment, the controller 146 is located within a control panel area 148 of the door 108, as shown in FIG. 1. In such an embodiment, input/output (“I/O”) signals may be routed between the control system and various operational components of dishwashing appliance 100 along wiring harnesses that may be routed through the bottom 110 of the door 108.

Typically, the controller 146 includes a user interface panel/controls 150 through which a user may select various operational features and modes and monitor progress of the dishwasher 100. In one embodiment, the user interface 150 may represent a general purpose I/O (“GPIO”) device or functional block. Additionally, the user interface 150 may include input components, such as one or more of a variety of electrical, mechanical or electro-mechanical input devices including rotary dials, push buttons, and touch pads. The user interface 150 may also include a display component, such as a digital or analog display device designed to provide operational feedback to a user. As is generally understood, the user interface 150 may be in communication with the controller 146 via one or more signal lines or shared communication busses.

Additionally, as shown in FIG. 2, a portion of the bottom wall 162 of the tub 104 may be configured as a tub sump portion 152 that accommodates a filter assembly 154 configured to remove particulates from the fluid being recirculated through the wash chamber 106 during operation of the dishwashing appliance 100. For example, fluid collected within the tub sump portion 152 of the bottom wall 162 may be passed through the filter assembly 154 and then diverted back to the pump 142 for return to the wash chamber 106 by way of the fluid recirculation assembly 140.

It should be appreciated that the present subject matter is not limited to any particular configuration, model, or style of dishwashing appliance. The example embodiment depicted in FIGS. 1 and 2 is simply provided for illustrative purposes only. For example, different locations may be provided for the user interface 150 and/or controller 146, different configurations may be provided for the racks 120, 122, and other differences may be applied as well.

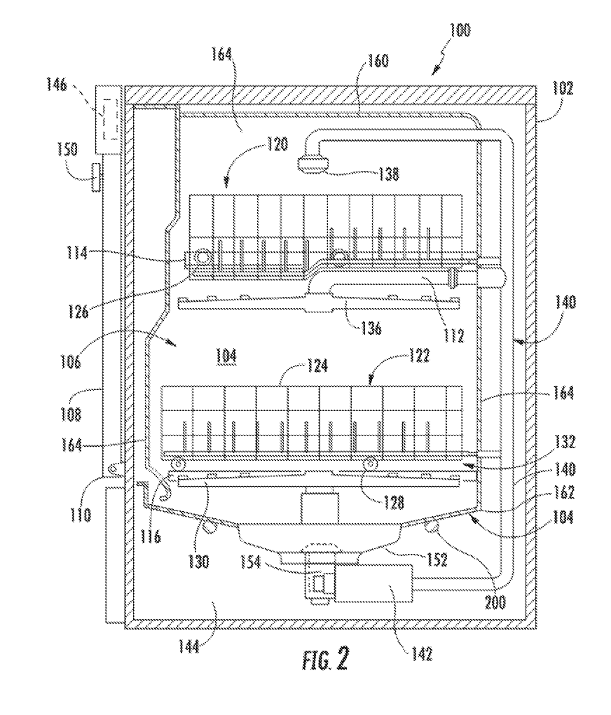

FIG. 3 depicts an overview of an example system 200 for controlling operation of a circulation pump motor of a dishwashing appliance based at least in part on a detected supply voltage. System 200 includes an alternating current (AC) power source 204. Power source 204 can be, for instance, a 120 VAC power source or other suitable power source. Power source 204 can be configured to provide power to a circulation pump motor 202. System 200 may further include a voltage detection circuit 206 configured to monitor one or more signals from power source 204. In example embodiments, voltage detection circuit 206 may be configured to monitor a voltage signal associated with power source 204 and/or a current signal associated power source 204. Voltage detection circuit 206 can be communicatively coupled to a controller 208. Controller 208 can include one or more processors 212 and memory 214. In some implementations, controller 208 can correspond to controller 146 of FIG. 2, or controller 208 can be a separate and distinct component from controller 146.

Voltage detection circuit 206 can provide one or more signals indicative of a supply voltage to controller 208. Controller 208 can be configured to determine or otherwise measure a supply voltage based at least in part on the one or more signals provided by voltage detection circuit 206. For instance, in some implementations, controller 208 can be configured to determine or otherwise measure the supply voltage based at least in part on a duty cycle of the one or more signals provided by voltage detection circuit 206.

Controller 208 can then be configured to determine one or more voltage control parameters associated with pump motor 202. As indicated above, the voltage control parameters can be determined based at least in part on a comparison between the measured supply voltage and a nominal supply voltage. For instance, the voltage control parameters can correspond to one or more firing angles at which to turn on a triac device configured to regulate current flow to pump motor 202. The firing angles can be determined to control an amount of voltage provided to pump motor 202, and to thereby control pump motor 202 to operate at a target operating speed. The amount of voltage provided to pump motor 202 can be determined to compensate for an increased or decreased motor speed caused by a supply voltage that deviates from the nominal supply voltage. In this manner, pump motor 202 can be operated at the target operating speed across a range of supply voltages. As indicated above, the voltage control parameters can be determined by accessing a lookup table stored, for instance, in memory 214.

Controller 208 can then send one or more signals indicative of the voltage control parameters to a motor speed control circuit 210. As indicated above, the motor speed control circuit 210 can include a triac device or other semiconductor device configured to regulate current flow to pump motor 202. In some implementations, the signals indicative of the voltage control parameters can correspond to a pulse train having a duty cycle determined in accordance with the triac firing angles. In particular, the control signals can be determined such that a gate pulse is provided to the gate of the triac device at the determined firing angle relative to each half cycle of the AC signal provided by power source 204. In this manner, at least a portion of each half cycle of the AC signal can be provided to pump motor 202, such that pump motor 202 operates substantially at the nominal motor speed across a range of supply voltages provided by power source 204.

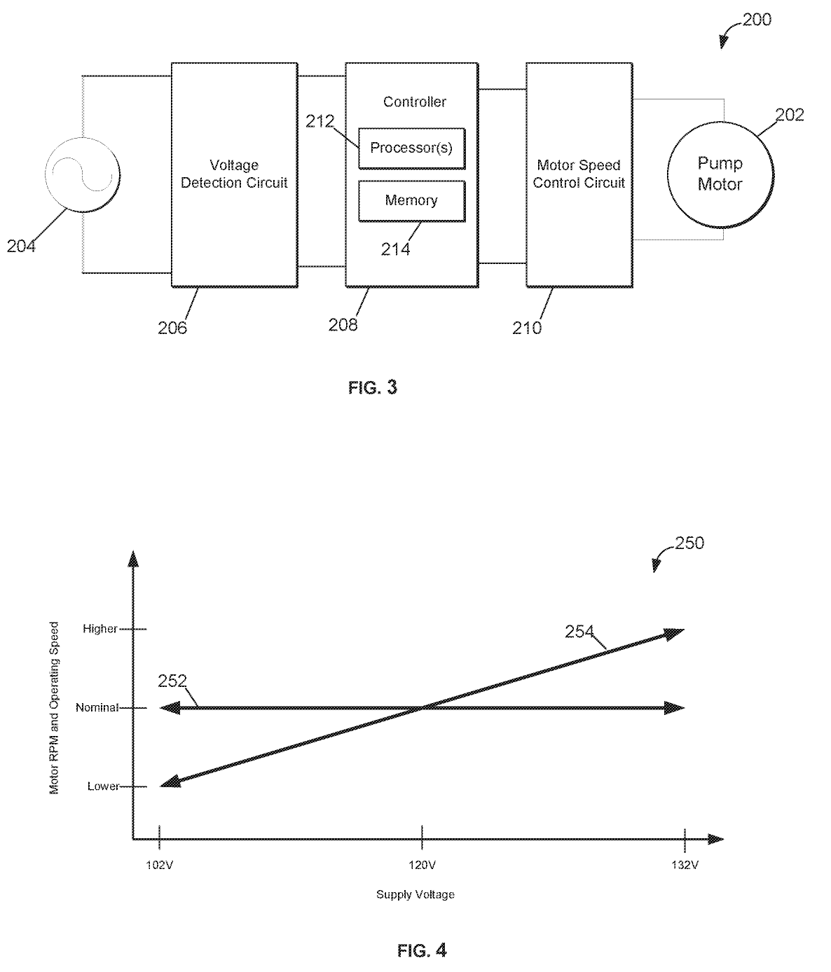

FIG. 4 depicts a chart 250 of motor speed over a range of supply voltages with and without speed compensation in accordance with example embodiments of the present disclosure. In particular, plot 252 corresponds to motor speed with speed compensation in accordance with example embodiments of the present disclosure. As shown, the motor speed is constant over the range of voltages (e.g. from 102V to 132V). As indicated above, such constant motor speed can be achieved by controlling the amount of voltage applied to the motor via a triac device. Plot 254 depicts motor speed over the same range of voltages without speed compensation according to example embodiments of the present disclosure. As shown, without such speed compensation, the motor speed will increase with the supply voltage, causing inefficient wash performance, and/or increased operating sound emitted during operation.

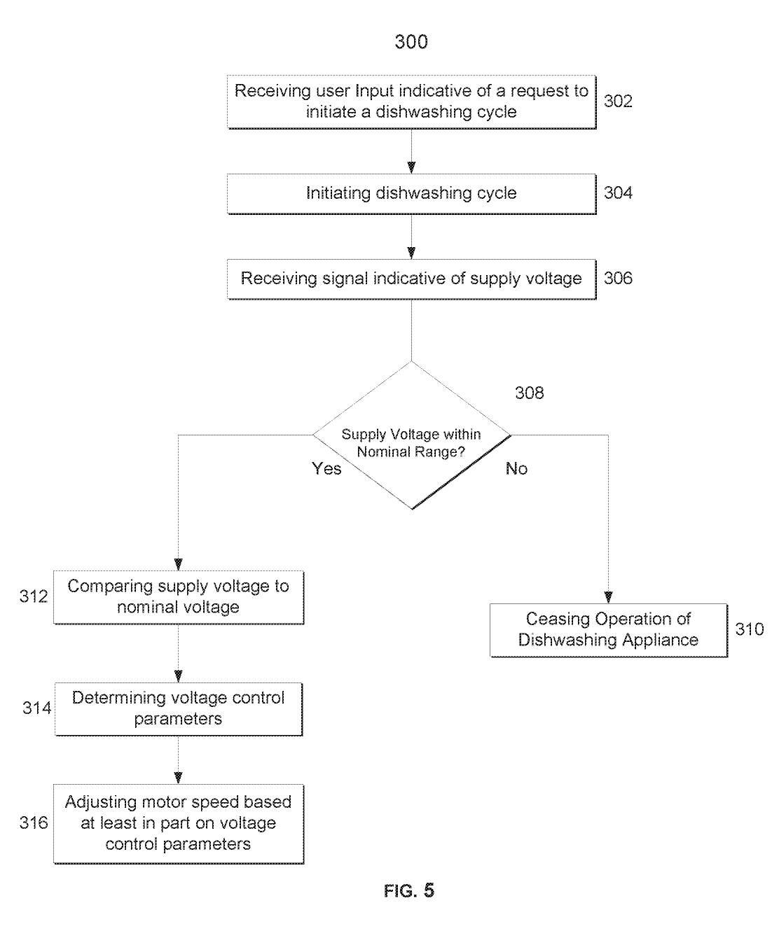

FIG. 5 depicts a flow diagram of an example method (300) of controlling operation of a motor associated with a dishwashing appliance according to example embodiments of the present disclosure. Method (300) can be implemented, for instance, by one or more of the devices depicted in FIGS. 1-3. In addition, FIG. 5 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

At (302), method (300) can include receiving a user input indicative of a request to initiate a dishwashing cycle. For instance, the user may input the request via user interface 150 of FIG. 2. At (304), method (300) can include initiating the dishwashing cycle.

At (306), method (300) can include receiving one or more signals indicative of a supply voltage associated with the dishwashing appliance. At (308), method (300) can include comparing the supply voltage to a nominal supply voltage range. The nominal range can correspond to a range of supply voltages, that when applied to the motor, cause the motor to operate in a safe manner. In this manner, supply voltages that fall outside the nominal range may, when applied to the motor, cause the motor to malfunction, or otherwise operate in a manner that is unsafe to the dishwashing appliance and/or a user of the dishwashing appliance.

When the supply voltage falls outside of the nominal range, method (300) can include ceasing operation of the dishwashing appliance (310). For instance, the dishwashing cycle can be aborted. In some implementations, an error or fault can also be reported. When the supply voltage falls within the nominal range, method (300) can include comparing the supply voltage to a nominal supply voltage (312). For instance, in some implementations the nominal supply voltage can be about 120V. As used herein, the term “about,” when used in conjunction with a numerical reference, is intended to refer to within about 40% of the numerical reference. For instance, the nominal supply voltage can be a supply voltage that, when applied to the motor, causes the motor to operate substantially at a target speed. As indicated, such target speed can correspond to an efficient performance of the dishwashing appliance.

In some implementations, the nominal voltage can be determined to correspond to between about 70% and 80% of the AC voltage signal provided by the voltage source. In this manner, the amount of voltage applied to the motor via the triac device can be increased or decreased by decreasing or increasing the triac firing angle, respectively.

At (314), method (300) can include determining one or more voltage control parameters based at least in part on the comparison of the supply voltage to the nominal supply voltage. As indicated the voltage control parameters can correspond to firing angles associated with a triac device configured to regulate current flow to the motor. In this manner, firing angles can be determined for each half cycle of the AC supply voltage signal. The firing angles can be determined such that some percentage of the AC voltage signal is provided to the motor. The percentage of the signal can correspond to the nominal voltage, and thereby to a target speed associated with the motor. As indicated above, such voltage control parameters and/or firing angles can be determined from a lookup table associated with the dishwashing appliance.

At (316), method (300) can include adjusting the motor speed based at least in part on the voltage control parameters. In particular, one or more gate pulses can be provided to the triac device, such that the triac device turns on at the corresponding firing angle associated with the AC supply voltage signal during each half cycle of the signal. In this manner, the signal provided to the motor can be a chopped AC signal having a duty cycle that corresponds to the triac firing angle.

Although specific features of various embodiments may be shown in some drawings and not in others, this is for convenience only. In accordance with the principles of the present disclosure, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method of controlling operation of a dishwashing appliance, the method comprising:
receiving data indicative of a supply voltage associated with a dishwashing appliance;
comparing the supply voltage to a nominal supply voltage associated with the dishwashing appliance;
determining one or more voltage control parameters based at least in part on the comparison of the supply voltage to the nominal supply voltage; and
adjusting a speed of a motor associated with the dishwashing appliance based at least in part on the voltage control parameters.

2. The method of claim 1, wherein determining one or more voltage control parameters comprises determining one or more firing angles associated with a triac device, the triac device configured to regulate an amount of voltage provided to the motor.

3. The method of claim 2, wherein the one or more voltage control parameters correspond to a chopped voltage waveform.

4. The method of claim 2, wherein determining one or more firing angles comprises determining one or more firing angle adjustments for the triac device to compensate for a difference between the supply voltage and the nominal supply voltage.

5. The method of claim 2, wherein adjusting a speed of a motor associated with the dishwashing appliance comprises controlling operation of the triac device in accordance with the one or more determined firing angles.

6. The method of claim 1, wherein adjusting a speed of a motor associated with the dishwashing appliance comprises adjusting the speed of the motor to substantially achieve a nominal motor speed.

7. The method of claim 1, further comprising comparing the supply voltage to a nominal supply voltage range.

8. The method of claim 7, further comprising, when the supply voltage falls outside of the nominal supply voltage range, ceasing operation of the dishwashing appliance.

9. The method of claim 1, further comprising:
receiving an input from a user indicative of a request to initiate a dishwashing cycle; and
initiating the dishwashing cycle based at least in part on the input from the user.

10. The method of claim 9, wherein receiving data indicative of a supply voltage comprises receiving data indicative of the supply voltage prior to initiation of the dishwashing cycle.

11. The method of claim 9, wherein receiving data indicative of a supply voltage comprises receiving data indicative of the supply voltage during the dishwashing cycle.

12. The method of claim 9, wherein initiating the dishwashing cycle comprises gradually increasing a voltage supplied to the motor from a first motor voltage to a second motor voltage.

13. The method of claim 1, wherein determining one or more voltage control parameters comprises accessing a lookup table stored in a memory associated with motor speeds of the dishwashing appliance.

14. A dishwashing appliance comprising:
a tub that defines a wash chamber for receipt of articles for washing;
a pump motor configured to direct a flow of fluid within the dishwashing appliance;
a power source coupled to the pump motor, the power source configured to provide an alternating current signal to the pump motor; and
one or more control devices configured to control operation of the pump motor by:
receiving data indicative of a supply voltage associated with the power source;
comparing the supply voltage to a nominal supply voltage associated with the dishwashing appliance;
determining one or more voltage control parameters based at least in part on the comparison of the supply voltage to the nominal supply voltage; and
adjusting a speed of the pump motor based at least in part on the voltage control parameters.

15. The dishwashing appliance of claim 14, wherein determining one or more voltage control parameters comprises determining one or more firing angles associated with a triac device, the triac device configured to regulate an amount of voltage provided to the motor.

16. The dishwashing appliance of claim 15, wherein the one or more firing angles are determined based at least in part on the nominal supply voltage.

17. The dishwashing appliance of claim 15, wherein adjusting a speed of the pump motor comprises controlling operation of the triac device in accordance with the one or more determined firing angles to substantially achieve a nominal motor speed.

18. A control system for a dishwashing appliance, the control system comprising one or more control devices configured to:
receive data indicative of a supply voltage associated with a dishwashing appliance, the dishwashing appliance comprising a tub that defines a wash chamber for receipt of articles for washing, a pump motor configured to direct a flow of fluid within the dishwashing appliance, and a power source coupled to the pump motor, the power source configured to provide an alternating current signal to the pump motor;
compare the supply voltage to a nominal supply voltage associated with the power source;
determine one or more voltage control parameters based at least in part on the comparison of the supply voltage to the nominal supply voltage; and
adjust a speed of the pump motor based at least in part on the voltage control parameters to substantially achieve a nominal motor speed.

19. The control system of claim 18, wherein determining one or more voltage control parameters comprises determining one or more firing angles associated with a triac device, the triac device configured to regulate an amount of voltage provided to the motor.

20. The control system of claim 19, wherein determining one or more firing angles comprises determining one or more firing angle adjustments for the triac device to compensate for a difference between the supply voltage and the nominal supply voltage.
